(19) United States
(12) Patent Application Publication
(10) Pub. No.: US 2017/0013917 A1
(43) Pub. Date: Jan. 19, 2017

(54) APPARATUS AND METHOD FOR PROLONGING AUTHENTIC NEW SHOE SMELL

(71) Applicant: Armando Vildosola, San Diego, CA (US)

(72) Inventor: Armando Vildosola, San Diego, CA (US)

(21) Appl. No.: 15/210,799

(22) Filed: Jul. 14, 2016

Related U.S. Application Data
(60) Provisional application No. 62/192,530, filed on Jul. 14, 2015.

(51) Int. Cl. A43C 19/00; B29C 47/00; B29B 13/02

(52) U.S. Cl. CPC A43C 19/00; B29B 13/022; B29C 47/0064; B29C 47/0066

(57) ABSTRACT

Composition of matter made from the same materials found in shoes to be placed inside a shoe to create and prolong the smell of the materials found in the manufacture of the shoe.

### CROSS-REFERENCE TO RELATED APPLICATIONS

This application claims priority to and the benefit of U.S. Provisional Application No. 62/192,530, titled “Apparatus and Method for Prolonging Authentic New Show Smell,” filed on Jul. 14, 2015, the disclosure of which is incorporated herein by reference in its entirety for all purposes.

### BACKGROUND

This document relates to shoes such as sneakers, and more particularly to an apparatus and method for prolonging, maintaining and/or restoring to a shoe the scent of a newly-made shoe.

Brand new shoes, such as and in particular sneakers, have a unique scent that is given off by an aggregate of the materials found within the shoe. Much like a “new car smell,” this scent is prominent at first, but diminishes quickly as the materials off-gas and age. Consumers of some shoes appreciate and value the scent of a newly made shoe. In fact, some shoes are acquired by enthusiasts not to be worn, but to be collected and sold or traded for value. To these enthusiasts, the scent of a newly made shoe is very important and can impact a shoe's value.

As of yet, there is no way of prolonging, maintaining and/or restoring the authentic scent of a newly made shoe to the shoe itself. Accordingly, what is needed is an article of manufacture and a method for providing a scent of a newly made shoe, and for introducing that scent back into a shoe of any age or condition.

### SUMMARY

To address the aforementioned problems and limitations in the field, this document presents apparatuses, articles of manufacture, and methods of making and using the same, for maintaining a scent of a newly-made shoe. In some implementations, an apparatus is made up of materials of rubbers, leathers, and foams that form the shoe, and can be readily inserted into and removed from the shoe as desired. In some aspects, one or more of these materials are formed into a rectangle, a sphere, a cylinder, or an angular form that is sized and adapted for placement into the shoe to maintain the scent of the newly-made shoe.

In some aspects, an article of manufacture includes scent-bearing materials at least partially or wholly encased with an air permeable layer, such as a mesh made of paper, plastic, metal, synthetic plastics, or natural plastics. The mesh holds together all the contents of scent-bearing materials, while allowing scents or odors to permeate from the scent-bearing materials to the inner surfaces of the shoe. The mesh further allows the article of manufacture to conform generally to the internal contours of the shoe.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings:

FIGS. 1A-E show various shapes for an article of manufacture in accordance with implementations described herein;

FIGS. 2A-D illustrate a mesh covering and holding materials in a shape that is dynamically changeable;

FIGS. 3A-D are internal views of article of manufacture showing possible shoe materials that can be shredded, solid, micro pieces, and or powder;

FIGS. 4A-C illustrate various methods of manufacturing a single solid piece in accordance with implementations described herein.

FIGS. 5A-C illustrate various implementations for the article of manufacture placed within a shoe;

FIG. 6 illustrates a specific way of creating the article of manufacture via flow chart;

FIGS. 7A-7D illustrate various implementations for producing the article of manufacture for placing within a shoe; and,

FIG. 8 illustrates a process for manufacturing a shoe scent-maintaining article.

Like reference symbols in the various drawings indicate like elements.

### DETAILED DESCRIPTION

This document describes an apparatus, article of manufacture, and method of making the same, for maintaining a scent of a newly-made shoe. In some implementations, an apparatus includes a collection of scent-bearing materials from a group of materials that includes one or more rubbers, leathers, foams, cloths, or the like, that form the newly-made shoe. The collection of materials is configured to approximate a percentage mix of the materials that form the shoe, in order to closely mimic the newly made shoe's unique scent. The apparatus further includes an air-permeable bounding layer of mesh made of paper, plastic, metal, synthetic plastics, or natural plastics to bind the collection of materials into a shape that can be readily inserted into and removed from the shoe.

In accordance with some exemplary implementations, the collection of materials for an apparatus include one or more materials found in shoes that has or has not been vulcanized: Polyacrylate Rubber, Ethylene-acrylate Rubber, Polyester Urethane, Bromo Isobutylene Isoprene, Polybutadiene, Chloro Isobutylene Isoprene, Polychloroprene, Chlorosulphonated Polyethylene, Epichlorohydrin, Ethylene Propylene, Ethylene Propylene Diene Monomer, Polyether Urethane, Perfluorocarbon Rubber, Fluoranated Hydrocarbon, Fluoro Silicone, Fluorocarbon Rubber, Hydrogenated Nitrile Butadiene, Polyisoprene, Isobutylene Isoprene Butyl, Acrylonitrile Butadiene, Polyurethane, Styrene Butadiene, Styrene Ethylene Butylene Styrene Copolymer, Polysiloxane, Vinyl Methyl Silicone, Acrylonitrile Butadiene Carboxy Monomer, Styrene Butadiene Carboxy Monomer, Thermoplastic Polyether-ester, Styrene Butadiene Block Copolymer, Styrene Butadiene Carboxy Block Copolymer, Leatherette, Koskin, Corfam, Poromeric imitation leather, Vegetable fibers, wood fiber, animal fibers, mineral fibers, biological fibers, biological fibers, semi-synthetic fibers, cellulose regenerated fibers, synthetic fibers, metallic fibers, carbon fiber, silicon carbide fiber, fiberglass, mineral fibers, polymer fibers, microfibers, suede, nubuck, canvas, vinyl, nylon, and cotton mesh.

The one or more materials are processed or manufactured into one or more pieces having an original scent of the newly made shoe and a binding agent that binds the one or more pieces of materials of the newly made shoe into a unitary piece of the one or more materials. In some implementations, an article of manufacture is formed into a rectangle, a sheet, a sphere, a cylinder, or a triangle, or any combination thereof. The article of manufacture is sized and adaptable for being insertable into a shoe so that a release of vapors from the collection of materials permeates into the shoe and maintains the scent of the newly made shoe.

In some implementations, a method of making a scent-maintaining article includes using scrap material having the scent of a newly made shoe from the manufacturing of newly made shoes, and cutting or chopping the scrap material into pieces ranging from 1 millimeter to 30 centimeters in length, from 1 millimeter to 20 centimeters in width, and 1 millimeter to 20 centimeters in height. The collection of scrap materials can be bound together, randomly or in a predetermined order, and in proportions corresponding to the material makeup of the shoe, by a mesh that is permeable to air. The mesh can be made of plastic, paper, metal, synthetic plastics, or natural plastics.

In alternative implementations, virgin materials found in shoes can be used, and cut or chopped into pieces ranging from 1 millimeter to 30 centimeters in length, from 1 millimeter to 20 centimeters in width, and 1 millimeter to 20 centimeters in height. These recycled materials can be held together by a mesh that is permeable to air. The mesh would be made of plastic, paper, metal, synthetic plastics, or natural plastics.

In yet other implementations, a collection of materials is provided and shredded into finer pieces that is pressed and bound together with a binding agent such as glue, thermal setting plastic, etc. This process can be accomplished using a mold, extrusion, or roller press. In still yet other implementations, an article of manufacture is formed by melting a collection of materials found in shoes into one homogenous substance that can be molded, set, pressed, or extruded into a final shape be it a triangle, sphere, rectangle, etc.

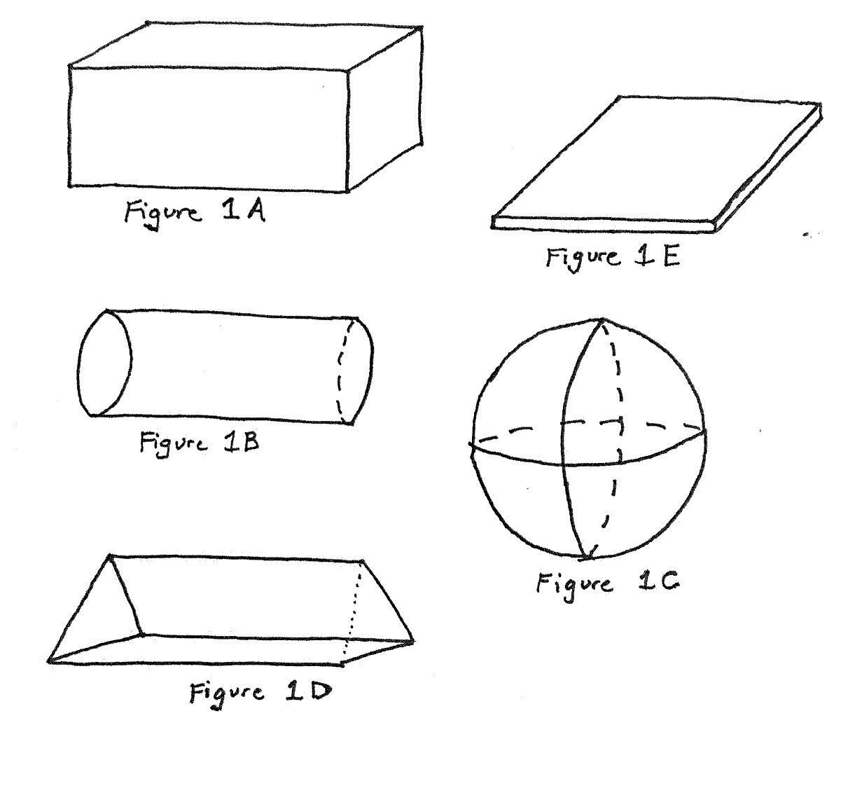

FIGS. 1A-E show various shapes for an article of manufacture in accordance with implementations described herein. As shown in FIG. 1A, an article of manufacture to provide a scent of a newly made shoe to a shoe of any age includes a collection of scent-bearing materials formed into a rectangular block. The rectangular block shape can be maintained either by a rectangular formed mesh binding the collection of materials together, or by pre-casting or pre-molding the collection of materials together. FIG. 1B shows an article of manufacture in a cylindrical configuration, and FIG. 1C shows an article of manufacture in a spherical configuration. FIG. 1D shows an article of manufacture in a triangular configuration, and FIG. 1E shows an article of manufacture in a planar sheet configuration. One or more articles of manufacture, of the same or different shape, can be combined and inserted into a shoe to occupy as much of the interior of the shoe as desired, or to contact as much of an interior surface of the shoe as needed. Still further, the article of manufacture can be formed into other shapes, such as a shape of a human foot.

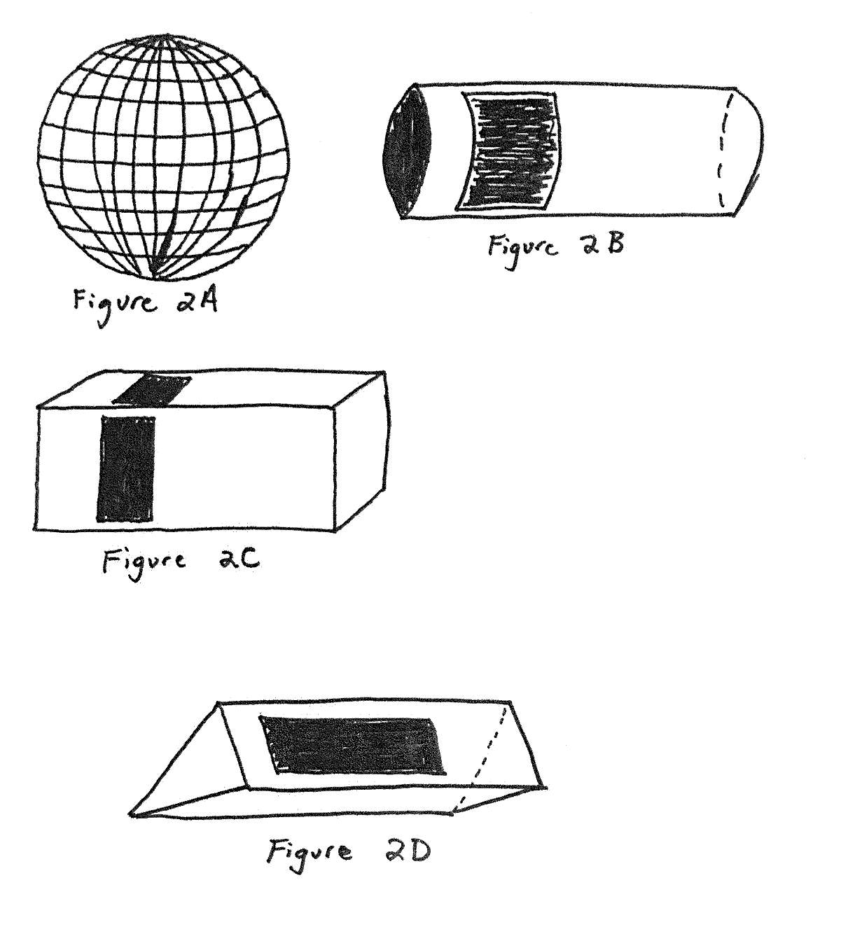

FIGS. 2A-D show various shapes for an article of manufacture covered and held together by a rectangular mesh in accordance with implementations described herein. As shown in FIG. 2A, an article of manufacture to provide a scent of a newly made shoe to a shoe of any age includes a collection of scent-bearing materials formed into a spherical configuration. The spherical shape is maintained by a rectangular formed mesh binding the collection of materials together. FIG. 2B shows an article of manufacture in a cylindrical configuration covered and held together by a rectangular formed mesh. FIG. 2C shows an article of manufacture in a rectangular configuration covered and held together by a rectangular formed mesh. FIG. 2D shows an article of manufacture in a triangular configuration covered and held together by a rectangular formed mesh. One or more articles of manufacture, of the same or different shape, can be covered and held together by a rectangular mesh.

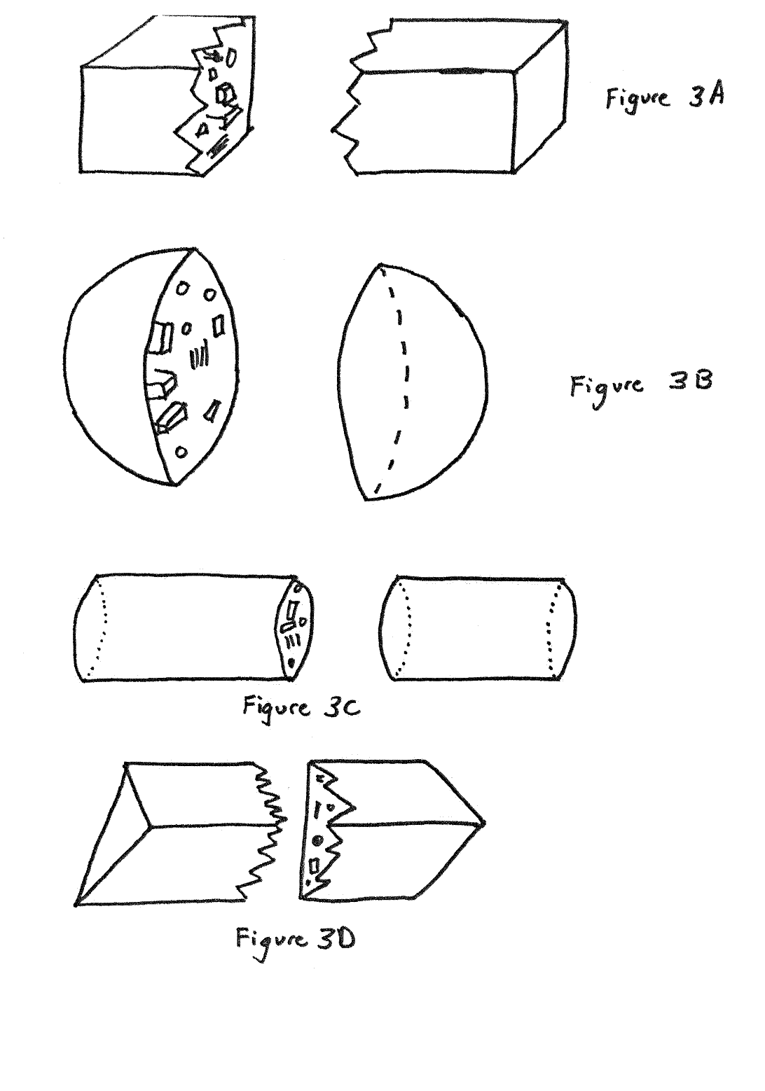

FIGS. 3A-D are cross-sectional views of article of manufacture showing possible shoe materials that can be shredded, solid, micro pieces, and or powder. FIG. 3A shows an article of manufacture in a rectangular configuration with a cross-sectional cutout showing the internal shoe materials. FIG. 3B shows an article of manufacture in a spherical configuration with a cross-section cutout showing the internal shoe materials. FIG. 3C shows an article of manufacture in a cylindrical configuration with a cross-sectional cutout showing the internal shoe materials. FIG. 3D shows an article of manufacture in a triangular configuration with a cross-sectional cutout showing the internal shoe materials. One or more of the materials found in shoes, in the form of shredded, solid, micro pieces, and or powder can be combined and inserted into the article of manufacture.

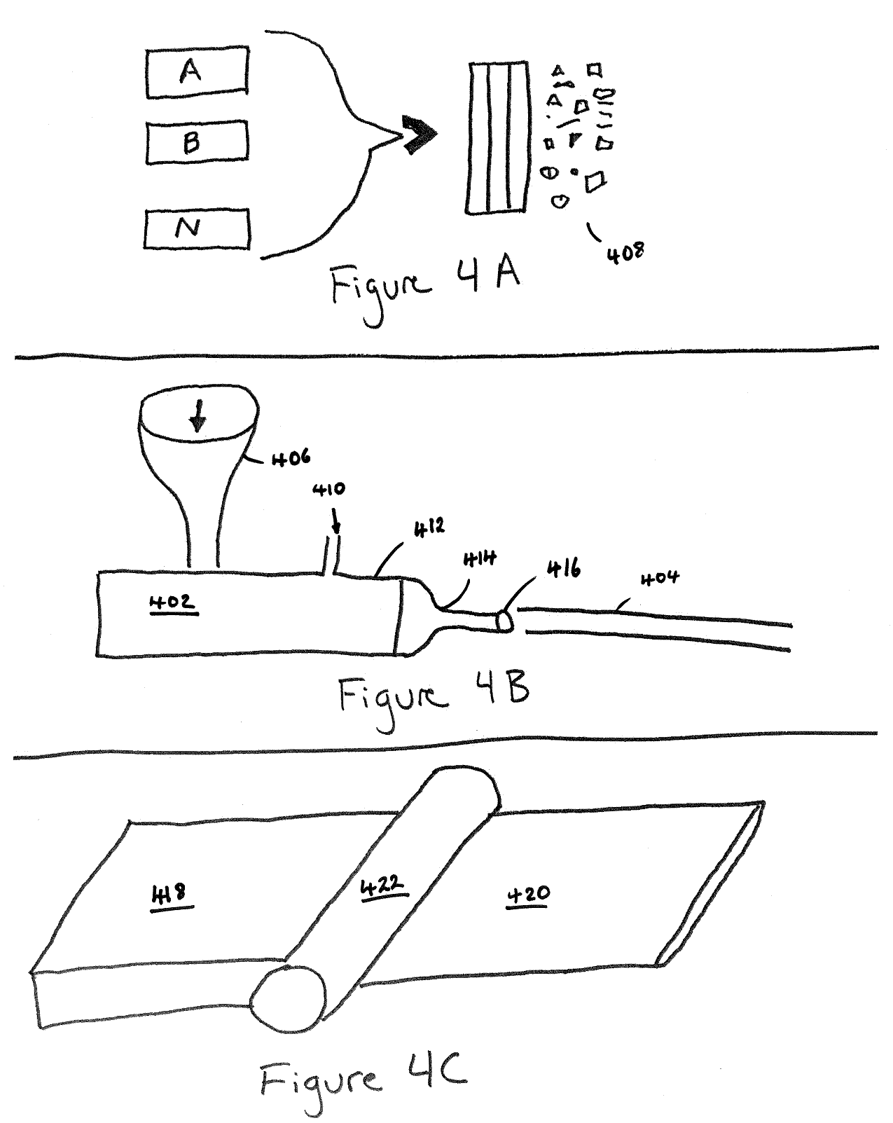

FIGS. 4A-C illustrate various methods of manufacturing a single solid piece as well as shredded pieces in accordance with implementations described herein. FIG. 4A shows the show materials being shredded into smaller pieces. Materials, such as materials A, B and N can be shredded into smaller materials, thereby increasing the surface area of materials A, B and N. FIG. 4B shows an apparatus 402 configured to produce a unitary piece of an article of manufacture 404, configured to provide a scent. The apparatus 402 can include a hopper 406 configured to facilitate the provision of shoe material, such as shredded shoe material 408 illustrated in FIG. 4A, into the apparatus 402. The apparatus 402 can be configured to thermally treat the shoe materials and combine the shoe materials with a binding agent 410 introduced into the apparatus 402. The apparatus 402 can be configured to force the thermally treated and bonded shoe materials through a neck 414 of the apparatus 402. The neck 414 can be configured to reduce the cross-sectional area of the shoe material. The thermally treated and bonded shoe materials can be extruded from a nozzle 416 of the apparatus, as a unitary piece 404, for downstream, processing. The extruded form 404 of scrap materials can be divided to form the shoe scent-maintaining article of a predetermined length and the predetermined cross sectional shape. The apparatus 402 can be configured to impart a desired cross-section shape onto the extruded form of scrap material. The neck 414 and/or nozzle 416 of the apparatus 402 can be shaped to provide an extruded form of scrap material having a desired shape. FIG. 4C shows a sheet 418 of the shoe materials being pressed into thinner sheets 420 by a roller 422. In some variations, the sheet 418 of shoe materials can be cut into smaller sheets of shoe material.

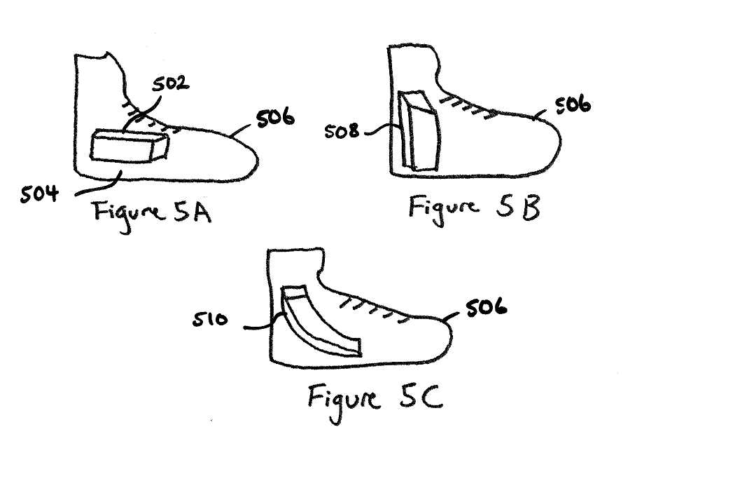

FIGS. 5A-C illustrate various implementations for the article of manufacture within a shoe. FIG. 5A shows the article of manufacture 502 horizontally placed along the base 504 of the shoe 506. FIG. 5B shows the article of manufacture 508 placed vertically inside a shoe 506. FIG. 5C shows the article of manufacture 510 placed both vertically and horizontally in a shoe 506 by bending said article of manufacture 510. One or more articles of manufacture, of the same or different shape, can be combined and inserted into a shoe to occupy a desired amount of the interior of the shoe, or to contact a desired amount of an interior surface of the shoe as needed.

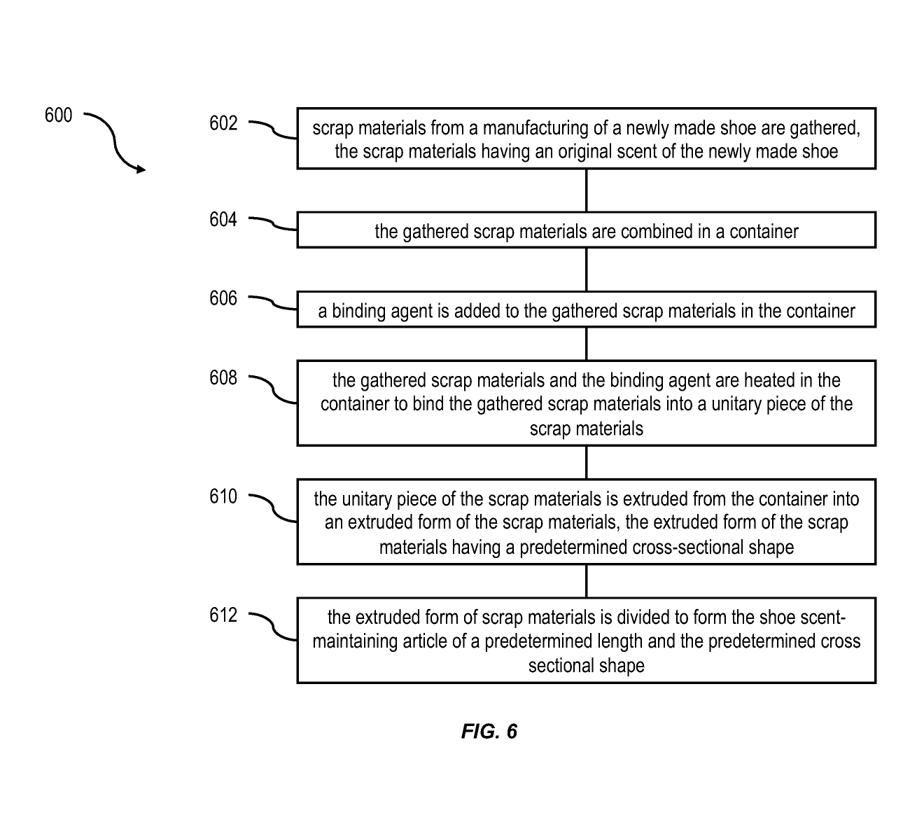

FIG. 6 is a flowchart of a method 600 of making a shoe scent-maintaining article. At 602, scrap materials from a manufacturing of a newly made shoe are gathered, the scrap materials having an original scent of the newly made shoe. At 604, the gathered scrap materials are combined in a container. In some implementations, the gathered scrap materials are combined in substantially the same proportion as the materials are used in the manufacturing of the newly made shoe. At 606, a binding agent is added to the gathered scrap materials in the container. At 608, the gathered scrap materials and the binding agent are heated in the container to bind the gathered scrap materials into a unitary piece of the scrap materials. At 610, the unitary piece of the scrap materials is extruded from the container into an extruded form of the scrap materials, the extruded form of the scrap materials having a predetermined cross-sectional shape. At 612, the extruded form of scrap materials is divided to form the shoe scent-maintaining article of a predetermined length and the predetermined cross sectional shape.

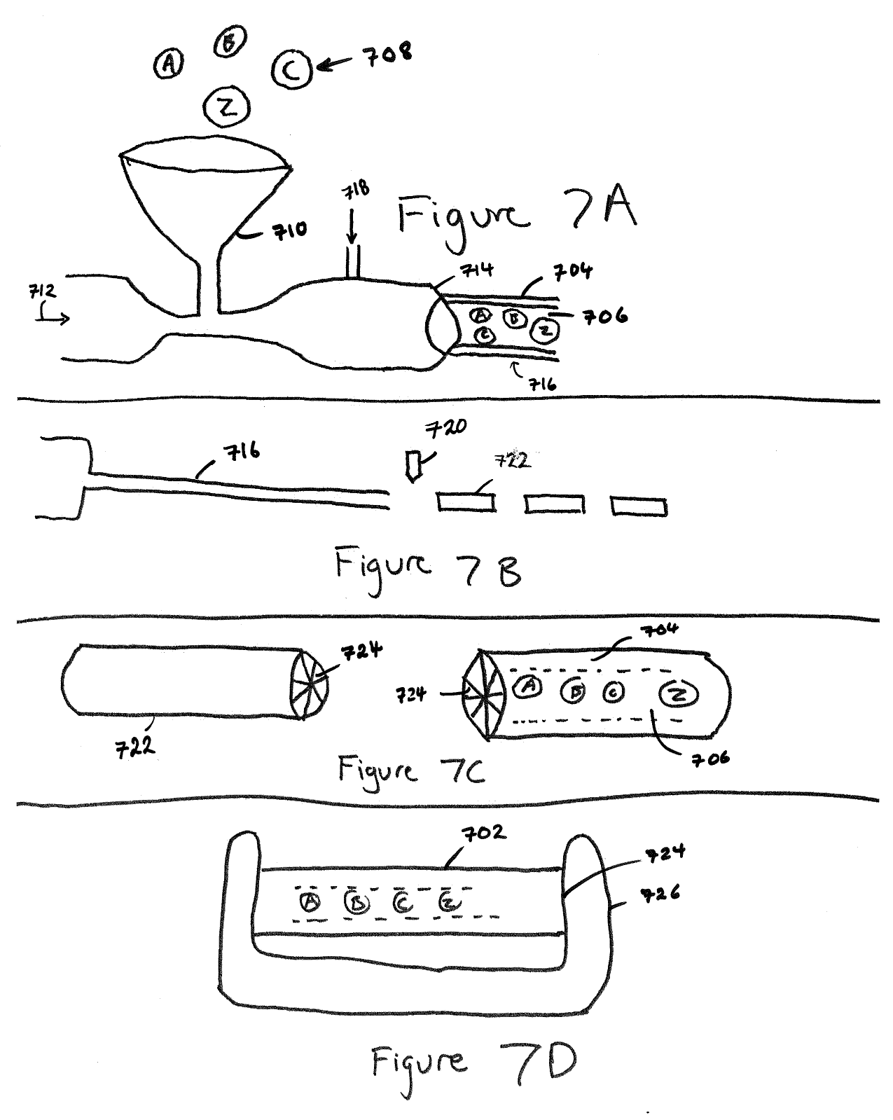

FIG. 7A-7D illustrate apparatuses and processes to produce a shoe scent-maintaining article 702, in accordance with implementations described herein. FIG. 7A shows the extrusion process that results in the exterior 704 of the shoe scent-maintaining article 702 being made of virgin materials while the interior 706 consists of scrap materials 708 from the manufacturing of shoes. Scrap materials 708 can be introduced into an apparatus 710 configured to facilitate production of a show scent-maintaining article 702. A casing material 712 can be introduced into the apparatus 710. In some variations, the casing material 712 can be virgin material for making into an exterior casing 704 of the scent-maintaining article 702. The virgin material can be made from one or more of a permeable polymer, a semi-permeable polymer, show material, or the like.

The apparatus 710 can be configured to extrude from a nozzle 714 a unitary piece 716. The unitary piece 716 can include an exterior casing 704 and an interior 706. The interior 706 can be formed from scrap material 708. In some variations, a binding agent 718 can be introduced into the scrap materials 708 to bind the scrap materials 708 together to form the interior 706 of the unitary piece 716. In other variations, the exterior casing 704 can be configured to bind the scrap materials 708 together to form the interior 706.

FIG. 7B shows the process of separating the single extruded product, or unitary piece 716, using a guillotine 720. The guillotine 720 can be configured to cut the unitary piece 716 into lengths of individual article pieces 722 of a desired length. While a guillotine 720 is illustrated, other cutting techniques are contemplated, for example, by a saw, circular saw, knife, or the like.

FIG. 7C shows an internal view of the article of manufacture, or individual article pieces 722, that consists of an interior portion 706 formed from scrap materials from the manufacture of shoes, and virgin materials forming an exterior portion 704. The individual article pieces 722 may comprise end portions 724. The end portions 724 can be covered with a mesh to ensure that the scrap materials forming the interior portion 706 are maintained with the individual article pieces 722. In some variations, where the scrap materials are bound using a binding agent, the end portions 724 can be left as they are after being cut.

FIG. 7D illustrates the process of sealing the end portions 724 of the article of manufacture, or individual article piece 722, to form the shoe scent-maintaining article 702. An end sealing apparatus 726 can be configured to apply heat to the end portions 724 of the individual article piece 722. The heat applied can be configured to melt and/or partially melt the end portions 724 of the individual article piece 722, thereby ensuring that the scrap material forming the internal portion 706 of the individual article piece 722 are maintained within the individual article piece 722 forming the show scent-maintaining article 702. In some variations, the heat applied by the end sealing apparatus 726 can facilitate binding the exterior portion 704 to the interior portion 706 in the vicinity of the end portions 724.

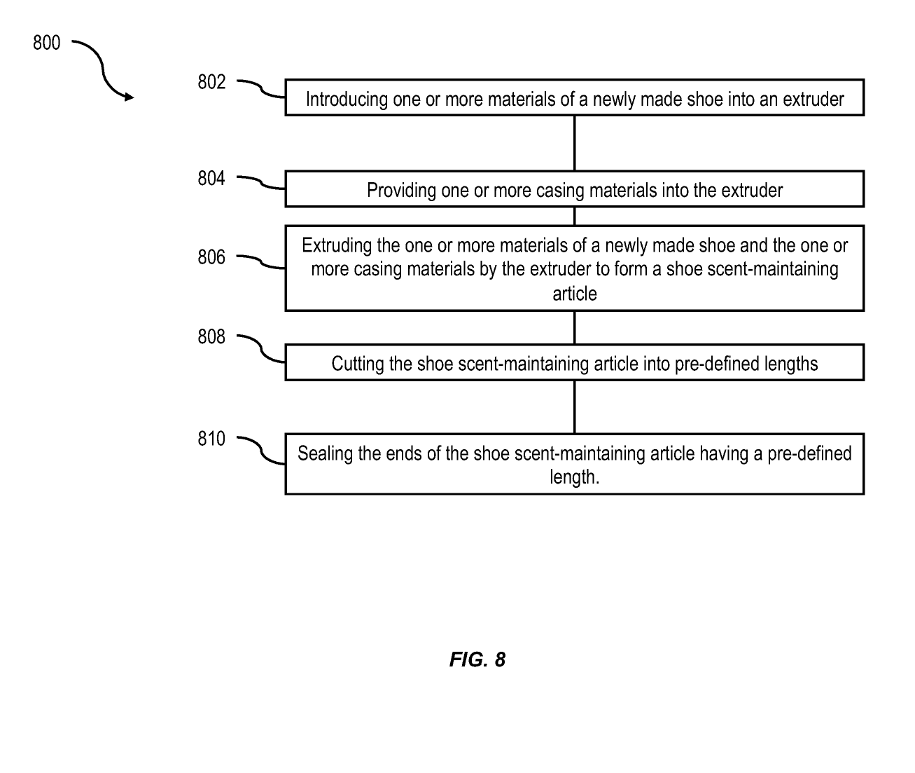

FIG. 8 illustrates a method 800 of making a shoe scent-maintaining article. At 802, one or more pieces of materials of a newly made shoe are introduced into an extruder. The one or more pieces of materials of a newly made shoe having a scent of a newly made shoe. The one or more pieces of materials of a newly made shoe may be scrap materials left over from the manufacture of shoes, pieces of the same types of materials that are used to make shoes, or the like.

At 804, providing one or more casing materials into the extruder.

At 806, the one or more pieces of materials of a newly made shoe and the one or more casing materials can be extruded by the extruder to form a shoe scent maintaining article. The shoe scent-maintaining article having a an inner portion formed from the one or more pieces of materials of a newly made shoe and an outer casing surrounding the inner portion formed from the one or more casing materials. The outer casing can be formed from a virgin material. The outer portion can be semi-permeable allowing the passage of the original scent of the newly made show from the inner portion.

At 808, the shoe scent-maintaining article can be cut into predefined lengths. The shoe scent-maintaining article can be cut using a guillotine, a saw, a knife, or the like.

At 810, the ends of the shoe scent-maintaining article can be sealed. The ends of the shoe scent-maintaining article can be sealed using a heated element applied to the ends of the shoe scent-maintaining article. The ends of the shoe scent-maintaining article can be sealed using a mesh that at least partially covers the first closed end and the second closed end to form the shoe scent-maintaining article, the mesh allowing passage of the original scent of the newly made shoe from the inner portion. The first closed end and the second closed end can be thermally treated to seal the first closed end and the second closed end. The sealed first closed end and the sealed second closed end can be configured to allow the passage of the original scent of the newly made show from the inner portion.

Although a few embodiments have been described in detail above, other modifications are possible. Other embodiments may be within the scope of the following claims.

1. A method of making a shoe scent-maintaining article, the method comprising:
gathering scrap materials from a manufacturing of a newly made shoe, the scrap materials having an original scent of the newly made shoe;
combining the gathered scrap materials in a container;
adding a binding agent to the gathered scrap materials in the container;
heating the gathered scrap materials and the binding agent in the container to bind the gathered scrap materials into a unitary piece of the scrap materials;
extruding the unitary piece of the scrap materials from the container into an extruded form of the scrap materials, the extruded form of the scrap materials having a predetermined cross-sectional shape; and
dividing the extruded form of scrap materials to form the shoe scent-maintaining article of a predetermined length and the predetermined cross sectional shape.

2. The method in accordance with claim 1, wherein the combining further includes combining the gathered scrap materials in substantially the same proportion as the materials are used in the manufacturing of the newly made shoe.

3. The method in accordance with claim 1, further comprising forming the shoe scent-maintaining article of the predetermined length and the predetermined cross sectional shape into a predetermined three-dimensional shape.

4. The method in accordance with claim 1, further comprising forming a casing around the unitary piece of scrap materials.

5. A shoe scent-maintaining article comprising:
one or more pieces of materials of a newly made shoe, the one or more pieces of materials having an original scent of the newly made shoe; and
a binding agent that binds the one or more pieces of materials of the newly made shoe into a unitary piece of the one or more materials;
the unitary piece of the one or more materials being heated and extruded into an extruded form of the one or more materials, the extruded form of the one or more materials having a predetermined cross-sectional shape, the extruded form of the one or more materials further being divided to form the shoe scent-maintaining article of a predetermined length and the predetermined cross sectional shape.

6. The shoe scent-maintaining article in accordance with claim 5, further comprising a casing around the unitary piece of the one or more materials.

7. A shoe scent-maintaining article comprising:
an inner portion comprising one or more pieces of materials of a newly made shoe, the one or more pieces of materials having an original scent of a newly made shoe;
an outer portion forming a casing around the inner portion; and,
a first closed end and a second closed end.

8. The shoe scent-maintaining article of claim 7, further comprising:
a mesh that at least partially covers the first closed end and the second closed end to form the shoe scent-maintaining article, the mesh allowing passage of the original scent of the newly made shoe from the inner portion.

9. The shoe scent-maintaining article of claim 7, wherein the first closed end and the second closed end are thermally treated to seal the first closed end and the second closed end.

10. The shoe scent-maintaining article of claim 9, wherein the sealed first closed end and the sealed second closed end are configured to allow the passage of the original scent of the newly made show from the inner portion.

11. The shoe scent-maintaining article of claim 7, wherein the outer portion is formed from a virgin material.

12. The shoe scent-maintaining article of claim 7, wherein the outer portion is semi-permeable allowing the passage of the original scent of the newly made show from the inner portion.
